(19) United States
(12) Patent Application Publication
(10) Pub. No.: US 2013/0031121 A1
(43) Pub. Date: Jan. 31, 2013

(54) VEHICLE CHARGING FACILITY INFORMATION ACQUISITION SYSTEM

(71) Applicants: Manabu Sera, Chigasaki-shi (JP); Kuniaki Kashiwagi, Nishinomiya-shi (JP)

(72) Inventors: Manabu Sera, Chigasaki-shi (JP); Kuniaki Kashiwagi, Nishinomiya-shi (JP)

(73) Assignee: NISSAN MOTOR CO., LTD., Yokohama, Kanagawa (JP)

(21) Appl. No.: 13/640,436

(22) PCT Filed: Apr. 13, 2011
(86) PCT No.: PCT/IB11/00822

§ 371 Date: Oct. 10, 2012

(30) Foreign Application Priority Data
Apr. 14, 2010 (JP) 2010-093076
Feb. 21, 2011 (JP) 2011-034335

(51) Int. Cl. G06F 17/30

(52) U.S. Cl. 707/758; 707/E17.014

(57) ABSTRACT

A vehicle charging facility information acquisition system has comprising an acquisition component and a charging record information storage component. The acquisition component is configured to acquire, from a plurality of vehicles, information pertaining to a vehicle charging facility as charging record information when the vehicles use the vehicle charging facility, with the information including at least vehicle charging facility position information. The charging record information storage component is configured to store the acquired charging record information in a charging record information database.

### CROSS-REFERENCE TO RELATED APPLICATIONS

This application claims priority to Japanese Patent Application Nos. 2010-093076 filed on Apr. 14, 2010 and 2011-034335 filed on Feb. 21, 2011. The entire disclosures of Japanese Patent Application Nos. 2010-093076 and 2011-034335 are hereby incorporated herein by reference.

### BACKGROUND

1. Field of the Invention

The present invention generally relates to a vehicle charging facility information acquisition system. More particularly, the present invention relates to a vehicle charging facility information acquisition system that acquires and stores information pertaining to a vehicle charging facility when a vehicle uses the vehicle charging facility.

2. Background Information

As electric and hybrid vehicles are becoming more popular, vehicle charging facilities for charging the batteries of such vehicles are becoming more widespread. Currently, systems exist that store information pertaining to the locations of vehicle charging systems in a database. These systems are capable of providing this location information to vehicle users. An example of such a system is described in Japanese Unexamined Patent Application Publication No. 2001-215124.

However, when a vehicle charging facility has been newly established, information pertaining to the newly established charging facility may not be present in the database. Therefore, a convention system may be unable to provide, for example, location information pertaining to the newly established vehicle charging facility to vehicle users. Accordingly, vehicle users may remain unaware of the newly established vehicle charging facility until the database is updated. As a result, the newly established vehicle charging facility may receive less than desired use during this initial period.

### SUMMARY

In view of the state of the known technology, a vehicle charging facility information acquisition system basically comprises an acquisition component and a charging record information storage component. The acquisition component is configured to acquire, from a plurality of vehicles, information pertaining to a vehicle charging facility as charging record information when the vehicles use the vehicle charging facility, with the information including at least vehicle charging facility position information. The charging record information storage component is configured to store the acquired charging record information in a charging record information database.

### BRIEF DESCRIPTION OF THE DRAWINGS

Referring now to the attached drawings which form a part of this original disclosure:

FIG. 1 is a block diagram showing an example of a vehicle charging facility information acquisition system according to a disclosed embodiment;

FIG. 2 is a flowchart illustrating an example of operations performed by the vehicle charging facility information acquisition system shown in FIG. 1;

FIG. 3 is a view illustrating an example of locations of vehicle charging facilities in relation to locations of vehicles;

FIG. 4 is a table illustrating an example of information pertaining to vehicle charging facilities that can be stored by the vehicle charging facility information acquisition system;

FIG. 5 is a table showing an example of information pertaining to a particular vehicle charging facility that can be stored by the vehicle charging facility information acquisition system;

FIG. 6 is a table showing another example of information pertaining to a particular vehicle charging facility that can be stored by the vehicle charging facility information acquisition system;

FIG. 7 is a view illustrating another example of locations of vehicle charging facilities in relation to locations of vehicles;

FIG. 8 is a table showing a further example of information pertaining to a particular vehicle charging facility that can be stored by the vehicle charging facility information acquisition system;

FIG. 9 is a table showing still another example of information pertaining to a particular vehicle charging facility that can be stored by the vehicle charging facility information acquisition system; and

FIG. 10 is a conceptual view showing an example of an exchange of information pertaining to vehicle charging facilities that can be performed by the vehicle charging facility information acquisition system as shown in FIG. 1.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

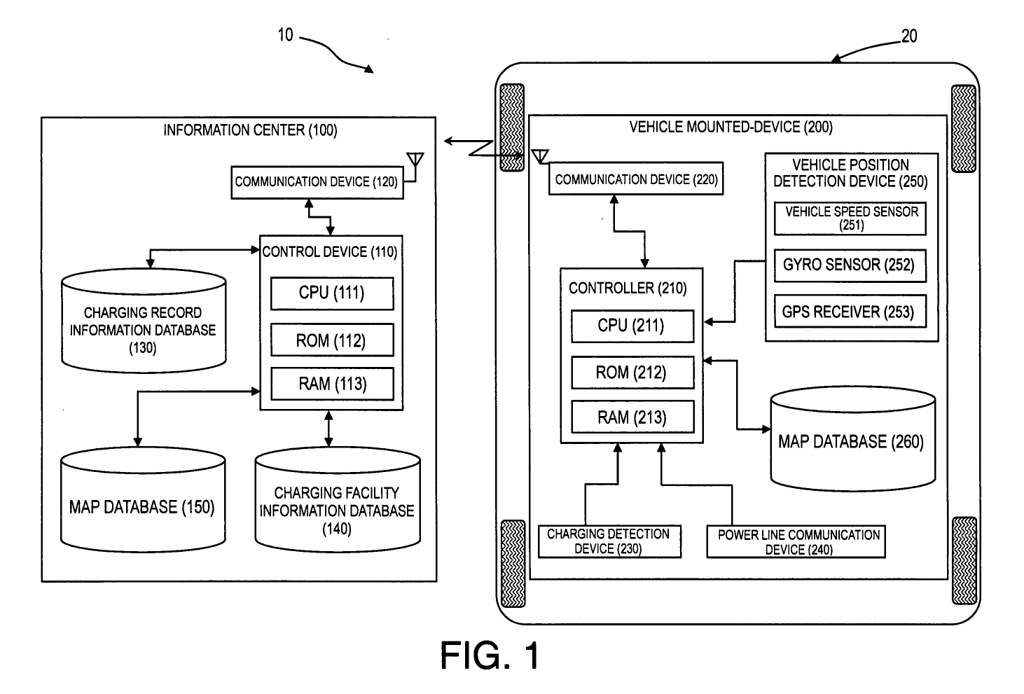

Referring initially to FIG. 1, an example of a vehicle charging facility information acquisition system 10 is schematically illustrated in accordance with a disclosed embodiment. As shown in FIG. 1, the vehicle charging facility information acquisition system 10 includes an information center 100 provided outside of a vehicle 20, such as an electric vehicle or a hybrid vehicle that can be a car, truck, SUV, van and so on, and which will be referred to generally as a vehicle 20. The vehicle charging facility information acquisition system 10 further includes a vehicle-mounted device 200 mounted to the vehicle 20. The information center 100 and the vehicle-mounted device 200 are capable of communicating with each other by wireless communication, such as radio frequency (RF) communication, using any suitable type of communication technique such as FDMA, CDMA, TDMA, QDMA, ad-hoc communication, peer-to-peer communication, telematics, and so on. Thus, the information center 100 and the vehicle-mounted device 200 are configured to exchange data via wireless communication as discussed above.

The vehicle-mounted device 200 will first be described. The vehicle-mounted device 200 is mounted in any suitable manner to the vehicle 20. The vehicle-mounted device 200 includes, for example, a controller 210, a communication device 220, a charging detection device 230, a power line communication device 240, a vehicle position detection device 250 and a map database 260. These components can be connected by, for example, a Controller Area Network (CAN) or other vehicle-mounted local area network (LAN) and are configured to exchange information with each other.

The communication device 220 in this example is configured to wirelessly communicate with a communication device 120 that is provided to the information center 100. As described in more detail below, the communication device 220 receives charging record information from the controller 210, and transmits the received charging record information by wireless communication to the communication device 120 of the information center 100. The communication device 220 also receives charging facility information (described below) that is wirelessly transmitted from the communication device 120 of the information center 100, and provides the received charging facility information to the controller 210.

In addition, the charging detection device 230 detects the charging classification of charging equipment of a vehicle charging facility when the vehicle 20 having the charging detection device 230 is connected to the charging equipment and charging is initiated. Examples of particular charging classifications include “rapid charging,” “100 V,” or “200 V,” as well as a classification as to whether the charging is a “plug-in” type charging facility, as discussed in more detail below.

The charging facility may also be a facility for replacing the battery of the vehicle 20 with a charged battery instead of charging the battery. In this case, the charging detection device 230 can be configured so as to detect “battery replacement” as a type of charging classification. Also, even when a vehicle's battery is replaced, the charging detection device 230 may be configured to determine that the battery is charged (e.g., the new battery is a charged battery).

As further shown in FIG. 1, the power line communication device 240 in this example is configured to perform power line communication with the charging equipment that is provided in the vehicle charging facility. When the vehicle 20 is connected to the charging equipment of the vehicle charging facility and the battery of the vehicle 20 is being charged via a power line, the power line communication device 240 acquires various types of information relating to the charging equipment installed at the vehicle charging facility. The information is provided from, for example, the charging,equipment. The information relating to the charging facility is not particularly limited, and can be different for each set of charging equipment. Examples of such information includes information pertaining to the location of the vehicle charging facility (e.g., the latitude and longitude of the vehicle charging facility), the name of the charging facility, the telephone number of the charging facility, the charging fee, and various other types of information.

The vehicle position detection device 250 of the vehicle-mounted device 200 is configured to detect the current position of the vehicle 20. In this example, the vehicle position detection device 250 includes a vehicle speed sensor 251 for detecting the speed of the vehicle 20, a gyro sensor 252 for detecting the travel direction of the vehicle 20, and a GPS receiver 253 for receiving a Global Positioning System (GPS) signal from, for example, a GPS satellite (not shown). Thus, the vehicle position detection device 250 detects the current position of the vehicle 20 on the basis of sensor outputs from the vehicle speed sensor 251 and the gyro sensor 252, and the GPS signal received by the GPS receiver 253. The vehicle position detection device 250 provides the detected vehicle position to the controller 210. The vehicle position detection device 250 also acquires the current time based on the GPS signal received by the GPS receiver 253, and provides the acquired current time to the controller 210.

The map database 260 in this example is a database provided with map data. The map data include node or link data which constitute road data, as well as information of charging facilities, road classification, road width, number of lanes in roads, speed limits, and other data. The map database 260 is also configured so that the information pertaining to newly established vehicle charging facilities that is transmitted from the information center 100 is provided to the map database 260 via the controller 210. Therefore, when the information pertaining to a newly established vehicle charging facility is provided to the map database 260, the information of the newly established vehicle charging facility is added to the map database 260.

It should also be noted that in this example, the controller 210 is provided with a Read Only Memory (ROM) 212 in which a program for executing various types of processing is stored a Central Processing Unit (CPU) 211 that is configured as an operation circuit for executing the program stored in the ROM, and a Random Access Memory (RAM) 213 that is configured to operate as an accessible storage device. Also, a Micro Processing Unit (MPU), a Digital Signal Processor (DSP), an Application Specific Integrated Circuit (ASIC), a Field Programmable Gate Array (FPGA), or the like may be used instead of or together with the CPU as an operation circuit.

The controller 210 executes a program stored in the ROM 212 through the use of the CPU 211 to perform a vehicle position specification function, a charging-time position information acquisition function, a charging time information acquisition function, and a charging classification information acquisition function The controller 210 further executes a program stored in the ROM 212 through the use of the CPU 211 to perform a charging-facility-provided information acquisition function, a charging record information generation function, a charging record information transmission function, and a map database update function. These functions are described in more detail below.

The vehicle position specification function of the controller 210 is a function for receiving the vehicle position detected by the vehicle position detection device 250 and specifying the location, such as the latitude and longitude, of the vehicle 20. The charging-time position information acquisition function of the controller 210 is a function for acquiring information pertaining to the vehicle location, such as the latitude and longitude of the vehicle 20, at the time of charging the battery of the vehicle 20. This information is acquired as charging-time position information when the vehicle 20 is connected to a charging device or other charging equipment of the vehicle charging . facility to charge the vehicle battery. Specifically, when the vehicle 20 is connected to the vehicle charging facility and charging of the battery is performed, the charging-time position information acquisition function acquires the vehicle position information specified by the vehicle position specification function for the time that the vehicle battery is being charged, and acquires the vehicle position information as charging-time position information.

The charging time information acquisition function of the controller 210 is a function for acquiring, as charging time information, information of the time at which the vehicle 20 is connected to the charging equipment of the vehicle charging facility to charge the vehicle battery. Specifically, the charging time information acquisition function acquires information pertaining to the current time transmitted by the vehicle position detection device 250. and uses this information as charging time information when the vehicle battery is being charged. In this example, the charging time information may include a charging start time indicating the time at which the vehicle 20 gets connected to the charging facility, and charging end time indicating the time at which charging of the vehicle battery is completed. The charging end time can indicate when, for example, the connection between the vehicle 20 and the vehicle charging facility is broken

The charging classification information acquisition function of the controller 210 is a function for acquiring, as charging classification information from the charging detection device 230, information pertaining to the charging classification of the charging equipment when the vehicle 20 is connected to the charging equipment of the vehicle charging facility to charge the vehicle battery. A charging classification can be “rapid charging,” “100 V,” “200 V,” or a classification as to whether the charging equipment is a “plug-in” type charging equipment.

The charging-facility-provided information acquisition function of the controller 210 is a function for acquiring, as charging-facility-provided information, information provided from the charging equipment by power line communication via the power line communication device 230 when the vehicle 20 is connected to the vehicle charging facility to charge the vehicle battery. The charging-facility-provided information can be different for each set of vehicle charging equipment, and is not particularly limited to any particular type of information. Examples of charging-facility-provided information includes the location, such as the latitude and longitude, of the vehicle charging facility, the name of the charging facility, the telephone number of the charging facility, the charging fee, and various other types of information as understood in the art.

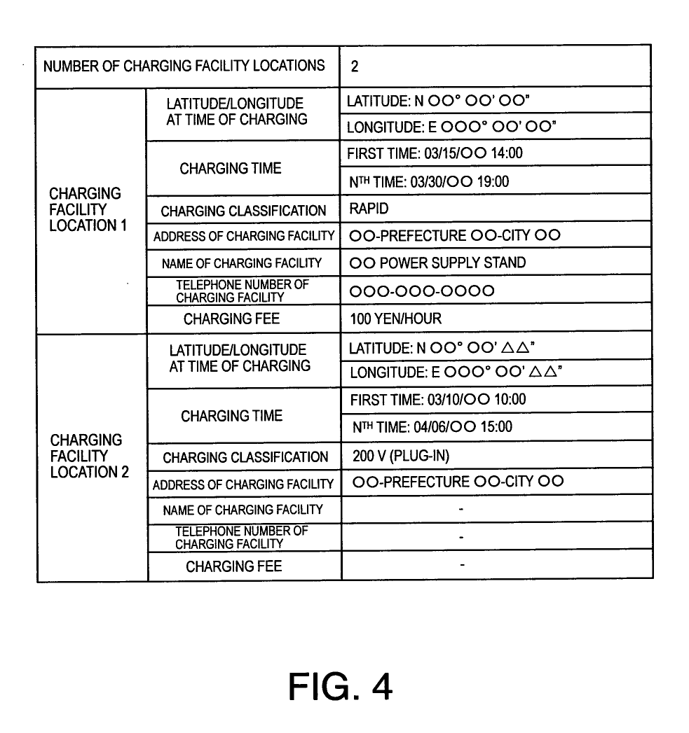

The charging record information generation function of the controller 210 generates charging record information on the basis of the charging-time position information, the charging time information, the charging classification information, and the charging-facility-provided information acquired by the charging-time position information acquisition function, the charging time information acquisition function, the charging classification information acquisition function, and the charging-facility-provided information acquisition function, respectively, described above. FIG. 4 shows an example of the charging record information according to a disclosed embodiment.

As shown in FIG. 4, the charging record information includes, for example, a “number of charging facility locations,” and information of each vehicle charging facility location. The information of each vehicle charging facility location can include, for example, the “latitude/longitude at a time of charging,” a “charging time,” a “charging classification,” and an “address of charging facility.” The information can further include a “name of charging facility,” a “telephone number of charging facility,” and a “charging fee.” In the example shown in FIG. 4, there are two vehicle charging facilities. Hence, “number of vehicle charging facility locations” is two, which are identified as “Charging Facility Location 1” and “Charging Facility Location 2.”

As stated, the “charging time” and the “charging classification” are based on the charging time information acquired by the charging time information acquisition function, and the charging classification information acquired by the charging classification information acquisition function, respectively. Therefore, the information of the charging time and the charging classification can be based on the information detected by the various devices of the vehicle-mounted device 200. In other words, the charging time information and charging classification information need not be provided from the charging equipment by power line communication, but instead can be based on the information detected within the vehicle 20. As shown in FIG. 4, the “charging time” information includes time information pertaining to the “first time,” which is the charging time at the initial charging. The “charging time” information further includes time information pertaining to the “N^{th} time,” which can correspond to the last charging time.

On the other hand, the “name of charging facility,” the “telephone number of charging facility,” and the “charging fee” can be based on information provided by the vehicle charging facility that can be acquired during the charging-facility-provided information acquisition function. Hence, these items of information can be based on the information provided from the charging equipment by power line communication via, for example, the power line communication device 230. Consequently, if the information from the charging equipment cannot be received via the power line communication, or only a portion of the information can be received via the power line communication, the processing can designate that there is “no information” for the abovementioned items in the charging record information. In other words, the processing can designate that no information is available by entering, for example, a “-” for the “name of charging facility,” the “telephone number of charging facility,” and the “charging fee” information for the “Charging Facility Location 2” as shown in FIG. 4.

In addition, the “latitude/longitude at time of charging” information can be set based on the charging-time position information, such as the latitude/longitude information for the vehicle 20 at the time of charging. This latitude/longitude information can be based on the information detected by the vehicle position detection device 250 on the vehicle 20. The latitude/longitude information can also be based on the information of the vehicle charging facility location, such as the latitude/longitude of the vehicle charging facility, which is provided from the charging equipment by power line communication. Specifically, when the information of the vehicle charging facility location (e.g., the latitude/longitude of the vehicle charging facility) is provided from the charging equipment by, for example, power line communication, the “latitude/longitude at time of charging” can be set based on the provided information.

On the contrary, when the information of the vehicle charging facility location (e.g., the latitude/longitude of the vehicle charging facility) is not provided, the “latitude/longitude at time of charging” can be set based on the charging-time position information (e.g., the latitude/longitude of the vehicle 20 at the time of charging). This charging-time position information can be based on the information detected by the vehicle position detection device 250. In other words, in this example, priority is placed on the information of the vehicle charging facility location that is provided from the charging equipment. By placing higher priority on the information of the vehicle charging facility position that is provided from the charging equipment, highly precise “latitude/longitude at time of charging” information can be obtained even when it is difficult to obtain accurate latitude/longitude information pertaining to the vehicle 20 itself (e.g., when the charging facility is located in an underground parking lot). In addition, the “address of charging facility” can be generated by referencing the map data stored, for example, in the map database 260, based on the information pertaining to the “latitude/longitude at time of charging.”

In this exemplary embodiment, when the charging record information is generated, the charging record information is generated for each “latitude/longitude at time of charging.” In other words, when there are different entries of the “latitude/longitude at time of charging,” charging record information is generated separately for each “latitude/longitude at time of charging.” Also, when a battery is charged once at a certain “latitude/longitude at time of charging,” and the battery is charged again at the same “latitude/longitude at time of charging,” the information is handled as being from the same location of charging. When charging is again performed at the same “latitude/longitude at time of charging,” the time information for the “N^{th} time” pertaining to the “charging time” information is updated to the newest charging time.

As discussed above, the controller 210 is also capable of performing a charging record information transmission function. The charging record information transmission function of the controller 210 is a function for transmitting the charging record information generated by the charging record information generation function to the communication device 220. The communication device 220 then transmits the charging record information via, for example, wireless communication as discussed above to the communication device 120 of the information center 100. Hence, the charging record information transmission function can operate as a charging record information transmission component that is configured to transmit information pertaining to a vehicle charging facility as charging record information from the vehicle to an information center when the vehicle 20 uses the vehicle charging facility, with the information including at least charging facility position information pertaining to a location of the vehicle charging facility.

The timing and interval of transmission of the charging record information can be any suitable times and durations. For example, the charging record information can be collected and transmitted at intervals of several days, each time a battery is charged, or at any other suitable intervals. Thus, the map database update function of the controller 210 adds/updates the information pertaining to a new vehicle charging facility in the map database 260 by providing the information of the new charging facility to the map database 260 based on the received charging facility information when vehicle charging facility information transmitted from the communication device 120 of the information center 100 is received by wireless communication via the communication device 220.

The information center 100 will now be described in more detail. As shown in FIG. 1, the information center 100 includes a control device 110, a communication device 120, a charging record information database 130, a charging facility information database 140, and a map database 150. The communication device 120 is configured to wirelessly communicate with the communication device 220 of the vehicle-mounted device 200 in any of the manners discussed above. Also, the communication device 120 receives, by wireless communication, the charging record information transmitted from the communication device 220 of the vehicle-mounted device 200, and provides the received charging facility information to the controller 210. The communication device 120 also receives charging facility information from the control device 110, and transmits the received charging facility information by wireless communication to the communication device 220 of the vehicle-mounted device 200.

In this example, the map database 150 includes a database provided with map data. The map data include node or link data which can be road data, as well as facility classification information, which can include information relating to the classification of facilities on the map (e.g., information as to whether a facility on the map is a company vehicle charging facility or other facility which cannot be publicly used), and other data. The control device 110 can include, for example, a ROM 112 in which a program for executing various types of processing is stored, a CPU 111 that functions as an operation circuit for executing the program stored in the ROM, and a RAM 113 that functions as an accessible storage device. An MPU, a DSP, an ASIC, an FPGA, or the like may be used instead of or together with the CPU as an operation circuit, in the same manner or a similar manner as in the controller 210 of the vehicle-mounted device 200 described above.

The control device 110 executes a program stored in the ROM 112 through the use of the CPU 111, and thereby performs a charging record information acquisition function, a same-location determination function, a charging facility information generation function and a charging facility information database update function. By executing the program stored in the ROM 112, the control device 110 can further perform a general availability determination function and a charging facility information transmission function.

The charging record information acquisition function of the control device 110 is a function for acquiring the received charging record information when charging record information is received by the communication device 120 by wireless communication. The charging record information acquisition function also provides the acquired charging record information to the charging record information database 130 which stores the charging record information. Hence, as discussed herein, the charging record information acquisition function of the control device 110 can operate as an acquisition component or acquisition means that is configured to acquire, from a plurality of vehicles 20, information pertaining to a vehicle charging facility as charging record information when the vehicles 20 use the vehicle charging facility. The information can include at least charging facility position information pertaining to a location of the vehicle charging facility.

The same-location determination function of the control device 110 can be a function for extracting the “latitude/longitude at time of charging” information which can include each set of charging record information for a particular vehicle charging station. The same-location determination function can make a same-location determination when a plurality of charging record information sets is acquired from different vehicle-mounted devices 200 provided on a plurality of different vehicles 20. Specifically, the same-location determination function can determine that certain charging record information relates to a particular vehicle charging facility when the “latitude/longitude at time of charging” information of the certain charging record information is within a predetermined error range of the latitude/longitude of the particular vehicle charging facility. For example, the same-location determination function can determine that the information relates to a particular vehicle charging facility when the information indicates that the latitude/longitude is within a diameter of, for example, 10 m or about 10 m of the particular vehicle charging facility.

The charging facility information generation function of the control device 110 generates charging facility information, which can include information pertaining to the vehicle charging facility, based on the charging record information acquired by the charging record information acquisition function. Hence, the charging facility information generation function of the control device 110 can function as a charging facility information generation component configured to generate, on the basis of the charging record information, charging facility information pertaining to the vehicle charging facility

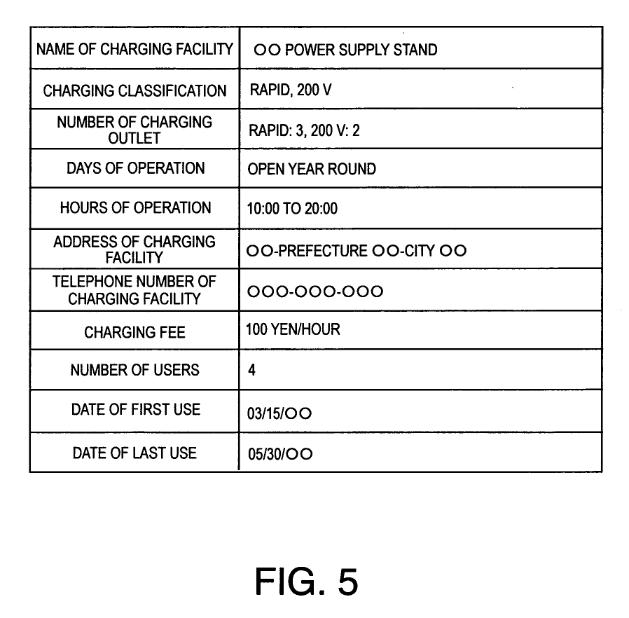

FIG. 5 shows an example of such vehicle charging facility information that is based on the information of “Charging Facility Location 1” in the charging record information shown in FIG. 4. As shown in FIG. 5, the charging facility information includes the “name of charging facility,” the “charging classification,” the “number of charging outlets,” the “days of operation” and the “hours of operation.” The charging facility information further includes the “address of charging facility,” the “telephone number of charging facility,” the “charging fee,” the “number of users,” the “date of first use,” and the “date of last use.”

The charging facility information database update function of the control device 110 is a function for generating newly generated charging facility information in the charging facility information database 140, and updating the charging facility information data which are stored in the charging facility information database 140. Hence, the charging facility information database update function can therefore function as a charging record information storage component that is configured to store the acquired charging record information in a charging record information database.

The charging facility information database 140 includes a database for storing the charging facility information generated by the charging facility information generation function of the control device 110. The general availability determination function of the control device 110 is a function for determining whether the charging facility that relates to the vehicle charging facility information is a vehicle charging facility that is generally available, such as a vehicle charging facility that is available the general public (i.e., whether the vehicle charging facility is available only to specific users). Thus, as discussed herein, the general availability determination function of the control device 110 can function as a determination component that is configured to determine, on the basis of the charging facility information, whether the vehicle charging facility that relates to the charging record information is a vehicle charging facility that is accessible by the plurality of vehicles 20.

The charging facility information transmission function of the control device 110 is a function for transmitting the charging facility information of a vehicle charging facility determined by the general availability determination function as being a vehicle charging facility that is generally available to the communication device 120, among the charging facility information generated by the charging facility information generation function. The transmitted charging facility information is transmitted by the communication device 120 by, for example, wireless communication to the communication device 220 provided to the vehicle-mounted device 200. Hence, the charging facility information transmission function can operate as an information providing component that is configured to provide to at least one of the vehicles 20 the information pertaining the vehicle charging facility that has been determined by the determination component to be accessible by the plurality of vehicles 20.

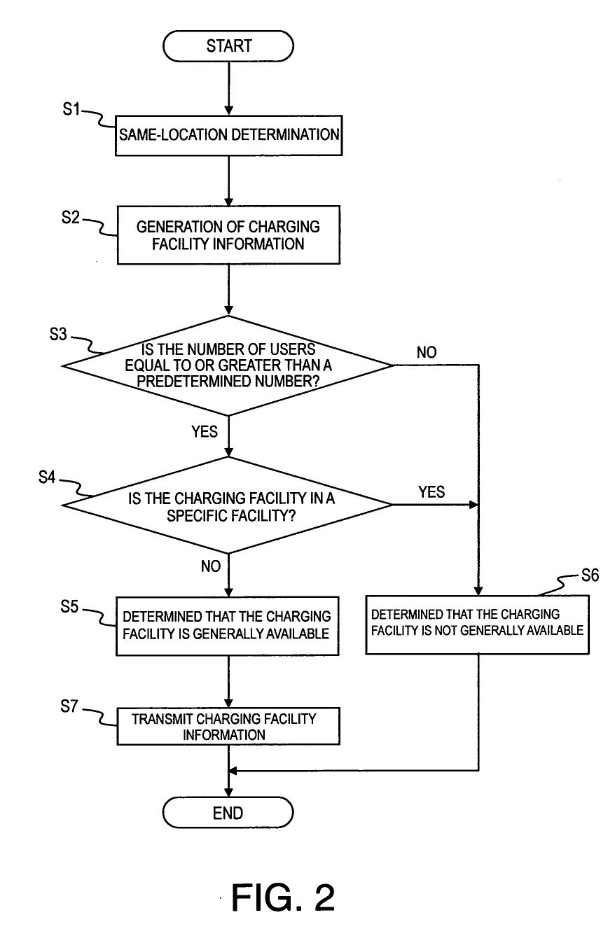

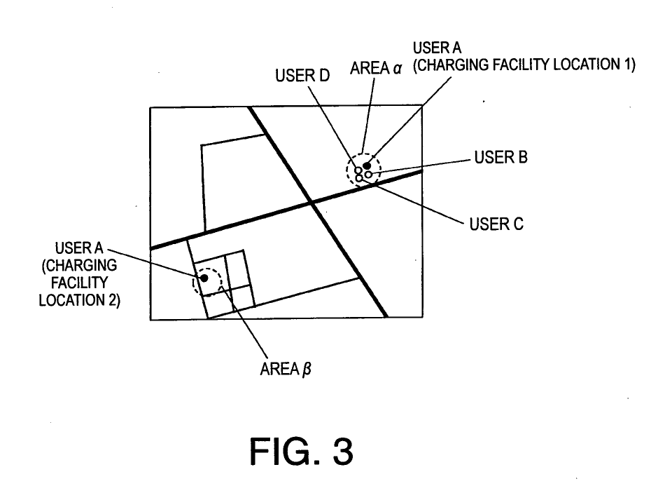

The processing performed by the vehicle charging facility information acquisition system according to a disclosed embodiment will now be described according to the exemplary flowchart shown in FIG. 2, and with reference to the exemplary situation shown in FIG. 3. FIG. 3 is a view showing an example of a situation in which the charging facility information provision processing according to a disclosed embodiment is applied. It should be understood that the process shown in FIG. 2 can be performed, for example, by the controller 210 or by any other suitable processor.

In the example situation shown in FIG. 3, a vehicle charging facility that is generally available is present at “Area a.” A vehicle charging facility that is not generally available is present at “Area fl.” An example of a vehicle charging facility that is not generally available can be a household power source or the like provided at the personal residence of user A that can be used only by user A or as permitted by user A. In the example shown in FIG. 3, user A charges a battery of user A′s vehicle 20 at “Charging Facility Location 1” in “Area a,” and at “Charging Facility Location 2” in “Area fl.” During each charging time, charging record information can be generated by the controller 210 of the vehicle-mounted device 200 on the vehicle 20 being driven, for example, by user A. The controller 210 can thus send the generated charging record information to the communication device 220 that transmits the information to the information center 100.

In the example situation shown in FIG. 3, in “Area a” in which “Charging Facility Location 1” is present, vehicle batteries of vehicles 20 other than the vehicle 20 being driven by user A can be charged. These other vehicles 20 are identified as user B, user C and user D. Accordingly, the controller 210 of the vehicle-mounted device 200 provided in each of the vehicles 20 of user B, user C and user D generates respective charging record information in a manner similar to the controller 210 of the vehicle 20 of user A. The vehicles 20 of users B, C and D thus transmit the respective generated charging record information to the information center 100. Since the charging record information for user B, user C and user D pertains to the vehicle charging facility at “Area a” which is generally available, the charging record information is substantially the same or substantially the same as the charging record information for “Charging Facility Location 1” of user A as discussed above with regard to FIGS. 4 and 5.

An example of the charging facility information processing that can be performed will now be described with regard to FIG. 2. In this example, the charging record information (i.e., the charging record information for “Charging Facility Location 1” and “Charging Facility Location 2”) shown in FIG. 4 is further received from the vehicle 20 of user A when the information center 100 has already received charging record information for the vehicle charging facility that is generally available in “Area a” from the vehicles 20 of users B, C and D.

The charging facility information processing based on the charging record information for “Charging Facility Location 1” will first be described. In step S1, the same-location determination function performed by the control device 110 extracts the “latitude/longitude at time of charging” information from the charging record information of “Charging Facility Location 1” shown in FIG. 4. Also, the charging record information database 130 is referenced to perform a same-location determination based on the extracted “latitude/longitude at time of charging” information. For example, in the example situation shown in FIG. 3, charging record information relating to the vehicle charging facility that is generally available in “Area a” is acquired from the vehicles 20 of users other than user A, such as the vehicles 20 of users B, C and D. The acquired charging record information is stored in the charging record information database 130. A determination is therefore made that the charging record information for “Charging Facility Location 1” from user A is charging record information obtained at the same location as the charging record information that is acquired from the vehicles 20 of users B, C and D.

In step S2, the charging facility information is generated by the charging facility information generation function of the control device 110 based on the charging record information transmitted from the communication device 220 of the vehicle-mounted device 200. Following is a description of an example of the method for generating the charging facility information in accordance with a disclosed embodiment. In this example, the charging facility information shown in FIG. 5 is generated from the charging record information for “Charging Facility Location 1” shown in FIG. 4.

The charging facility information generation function of the control device 110 first extracts the “name of charging facility,” “address of charging facility,” “telephone number of charging facility” and “charging fee” information from the charging record information of “Charging Facility Location 1” shown in FIG. 4. The charging facility information generation function then designates the extracted information as the corresponding information that includes the charging facility information shown in FIG. 5. In other words, in the examples shown in FIGS. 4 and 5, the charging facility information generation function designates the “name of charging facility” of the charging facility information shown in FIG. 5 as “◯◯ power supply stand” based on the “name of charging facility” information of the charging record information of “Charging Facility Location 1” shown in FIG. 4. In the same or a similar manner, “◯◯-prefecture ◯◯-city ◯◯,” “◯◯-◯◯◯-◯◯◯◯,” and “100 yen per hour” are designated as the “address of charging facility,” the “telephone number of charging facility” and the “charging fee,” respectively.

In this example, the same-location determination function of the control device 110 determines in step Si that the charging record information of “Charging Facility Location 1” from user A is charging record information obtained at the same location as the charging record information acquired from the vehicles 20 of users B, C and D as described above. Therefore, in this example, the charging facility information generation function determines the information other than the information described above based on the charging record information of “Charging Facility Location 1” provided from the vehicle 20 of user A, as well as the charging record information already acquired from the vehicles 20 of users B, C and D. That is, the charging facility information generation function determines information pertaining to the “charging classification,” the “number of charging outlets,” the “days of operation,” the “number of users,” the “date of first use” and the “date of last use” based on the charging record information of “Charging Facility Location 1” from user A, as well as the charging record information already acquired from users B, C and D. Specifically, when the charging record information of the vehicles 20 of users other than user A (e.g., users B, C and/or D) includes information indicating that the “charging classification” is “200 V” and “rapid charging” is indicated in the charging record information of “Charging Facility Location 1” from the vehicle 20 of user A as shown in FIG. 4, the charging facility information generation function sets the “charging classification” information as “rapid, 200 V” as shown in FIG. 5.

In addition, the number of user vehicles 20 charging at the same time is detected based on the “charging time” information in the charging record information from the vehicles 20 of users A, B, C and D, and the “number of charging outlets” information in the charging facility information is set based on the detected result. For example, when rapid charging is occurring by three user vehicles 20 at the same time, and 200 V charging by two user vehicles 20 at the same time is detected based on the charging record information from the vehicles 20 of users A, B, C and D, the charging facility information generation function sets “3 outlets for rapid, 2 outlets for 200 V” as the “number of charging outlets” as shown in FIG. 5.

Furthermore, the distribution of the “charging time” can be calculated based on the “charging time” information in the charging record information provided from the vehicles 20 of users A, B, C and D. Also, the “days of operation” and “hours of operation” in the charging facility information can be set based on the calculated distribution. For example, FIG. 5 shows an example in which the charging facility information generation function determines that charging is being performed every day regardless of the day of the week based on the calculated distribution. Accordingly, the “days of operation” is set to “open year round” as a result of calculating the distribution of the “charging time”. As a result of calculating the “charging time” distribution, a determination is made that the times of charging are distributed between 10:00 and 20:00. Hence, based on this determination, the charging facility information generation function sets the “hours of operation” information to “10:00 to 20:00.”

In addition, the “number of users” in the charging facility information is set based on the number of users for which the determination when the same-location determination function determines that the charging record information is obtained at the same location. Specifically, in the example shown in FIG. 3, since the vehicles 20 of user A, user B, user C and user D equals four users, the “number of users” is set to “4” as shown in FIG. 5.

Furthermore, the “date of first use” and the “date of last use” in the charging facility information are set based on the “charging time” information in the charging record information received from the vehicles 20 of users A, B, C and D. In the example shown in FIG. 5, the “date of first use” is set to “03/15/00” based on the earliest time in the “charging time” of the charging record information received from the vehicles 20 of users A, B, C and D. Also, the “date of last use” is set to “05/30/00” based on the latest time in the “charging time” of the charging record information.

According, in step S2, the charging facility information is generated by the charging facility information generation function in the manner described above. In steps S3 through S6, the general availability determination function of the control device 110 determines whether the vehicle charging facility that relates to the charging facility information generated in step S2 is a vehicle charging facility that is generally available (i.e., whether the vehicle charging facility is available only to specific users).

In other words, the general availability determination function of the control device 110 determines in step S3 whether the “number of users” included in the charging facility information is equal to or greater than a predetermined number. When the “number of users” is determined to be equal to or greater than the predetermined number, the process proceeds to step S4. However, when the “number of users” is determined to be less than a predetermined number, the process proceeds to step S6. In step S6, a determination is made that the vehicle charging facility that relates to the charging facility information is not generally available. Hence, the charging facility information is stored in the charging facility information database 140, and the processing ends. Accordingly, when the “number of users” is one or greater than one but an extremely small number, it is possible to determine that the vehicle charging facility that relates to the charging facility information is not a power supply stand or other vehicle charging facility that is generally available. Rather, the vehicle charging facility is determined to be a household power source or other charging facility that is available only to specific users.

For example, as shown in FIG. 3, the “number of users” for the vehicle charging facility present in “Area α” is determined to be four. In this example, the determination is made that the “number of users” is equal to or greater than the predetermined number, and the process proceeds to step S4.

In step S4, the facility classification information included in the map database 150 is referenced by the general availability determination function based on the “address of charging facility” information included in the charging facility information. Hence, a determination is made as to whether the vehicle charging facility that relates to the charging facility information corresponds to a specific facility that is available only to a company or other specified large number of users. When the “address of charging facility” corresponds to the address of a specific facility having a vehicle charging facility that is available to a large number of users but is not available to the general public, the process proceeds to step S6. In step S6, a determination is made that the vehicle charging facility is not generally available. The charging facility information is then stored in the charging facility information database 140, and the processing ends.

On the other hand, when the “address of charging facility” does not correspond to the address of a specific facility, the process proceeds to step S5. In step S5, a determination is made that the vehicle charging facility that relates to the charging facility information is a vehicle charging facility that is generally available, and the charging facility information is stored in the charging facility information database 140. The processing then continues to step S7.

In step S7, the charging facility information of the vehicle charging facility that is determined to be a generally available vehicle charging facility is provided to the communication device 120 by the charging facility information transmission function of the control device 110. The communication device 120 transmits charging facility information by, for example, telematics or other wireless communication to the communication device 220 that is provided to the vehicle-mounted device 200.

For example, when the vehicle charging facility present in “Area α” of FIG. 3 does not correspond to a company or other specific facility, the charging facility information shown in FIG. 5 is transmitted by the communication device 120 by wireless communication to the communication device 220 of the vehicle-mounted device 200. On the other hand, when the vehicle charging facility present in “Area α” corresponds to a company or other specific facility, the charging facility information shown in FIG. 5 is not transmitted to the communication device 220.

According, the processing based on the charging record information for “Charging Facility Location 1” can be performed in the exemplary manner described above. The processing based on the charging record information for “Charging Facility Location 2” can be performed at the same time or substantially the same time as the processing that is based on the charging record information for “Charging Facility Location 1,” or at a different time.

In step S1, a same-location determination is performed by the same-location determination function of the control device 110. In the example shown in FIG. 3, no vehicle 20 other than the vehicle 20 of user A are charging a battery at the vehicle charging facility which is present at “Area β.” Therefore, no charging record information relating to the vehicle charging facility in “Area β” is acquired from vehicles 20 of users other than user A. A determination is therefore made that there is no charging record information obtained at the same location in the charging record information for “Charging Facility Location 2” provided from user A.

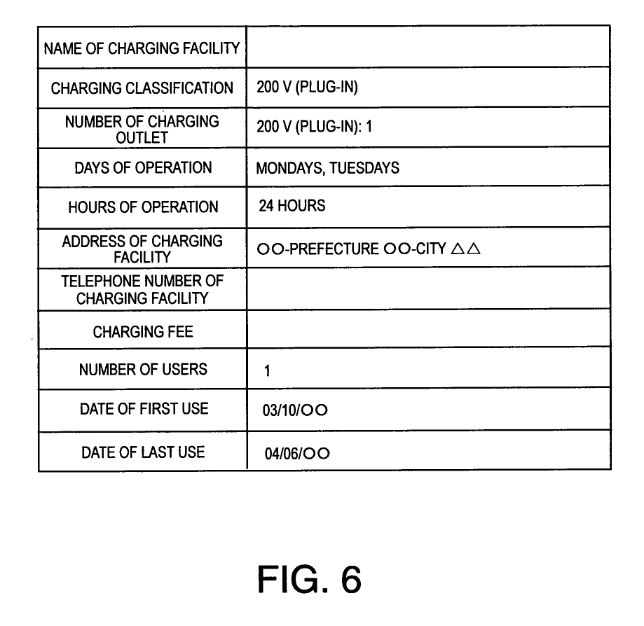

In step S2, the charging facility information generation function of the control device 110 generates charging facility information based on the charging record information for “Charging Facility Location 2” received from the vehicle 20 of user A. FIG. 6 shows an example of the charging facility information that is generated from the charging record information of “Charging Facility Location 2” shown in FIG. 4.

First, the charging facility information generation function extracts the “address of charging facility” information in the charging record information of “Charging Facility Location 2” shown in FIG. 4. Then, the charging facility information generation function designates the “address of charging facility” of the charging facility information shown in FIG. 6 as “◯◯-prefecture ◯◯-city ΔΔ.” Also, since the “name of charging facility,” “telephone number of charging facility” and “charging fee” information are not included in the charging record information of “Charging Facility Location 2” shown in FIG. 4, the charging facility information generation function designates “no information” (indicated by “-” in FIG. 6) for the “name of charging facility,” “telephone number of charging facility” and “charging fee” information in the charging facility information shown in FIG. 6.

As described above, since a determination is made in step Si that there is no charging record information obtained at the same location in the charging record information for “Charging Facility Location 2” from the vehicle 20 of user A, the charging facility information generation function determines the information other than the information described above which constitutes the charging facility information based on the charging record information for “Charging Facility Location 2” received from the vehicle 20 of user A. That is, unlike the related process for “Charging Facility Location 1” as described above, the “charging classification,” the “number of charging outlets,” the “days of operation,” the “number of users,” the “date of first use” and the “date of last use” information is generated based on the charging record information for “Charging Facility Location 2” from the vehicle 20 of user A.

Specifically, the charging facility information generation function sets the “charging classification” information of the charging facility information to “200 V (plug-in)” based on the “charging classification” of the charging record information of “Charging Facility Location 2” from the vehicle 20 of user A shown in FIG. 4. Also, as discussed above, a determination is made in step Si that there is no charging record information that is obtained at the same location in the charging record information of “Charging Facility Location 2” from the vehicle 20 of user A. As a result, the “number of charging outlets” information in the charging facility information is set to “200 V (plug-in) 1 outlet” based on the charging record information of “Charging Facility Location 2” from the vehicle 20 of user A as shown in FIG. 6.

Furthermore, the distribution of the “charging time” is calculated based on the “charging time” information in the charging record information of “Charging Facility Location 2” from the vehicle 20 of user A. Also, the “days of operation” and “hours of operation” in the charging facility information are set based on the calculated distribution. For example, in the example shown in FIG. 6, the “days of operation” is set to “Mondays, Tuesdays” as a result of calculating the distribution of the “charging time.” FIG. 6 also shows an example in which a determination is made that charging is performed regardless of the time as a result of calculating, for example, the “charging time.” Based on this determination, the “hours of operation” is set to “24 hours” by the charging facility information generation function. Hence, charging facility information is generated based on the charging record information for “Charging Facility Location 2” in the manner described above.

In addition, in the example shown in FIG. 6, the “number of users” in the charging facility information generated in step S2 is one. Accordingly, a determination is made in step S3 that the “number of users” is less than a predetermined number. The process then proceeds to step S6, and a determination is made that the vehicle charging facility is not generally available, and is a household power source or the like that is, for example, at the personal residence of user A. Accordingly, the charging facility information is stored in the charging facility information database 140, and the processing ends.

Thus, the processing performed by the vehicle charging facility information acquisition system 10 based on the charging record information of “Charging Facility Location 1” and “Charging Facility Location 2” in the example shown in FIG. 3 can be executed in the manner described above.

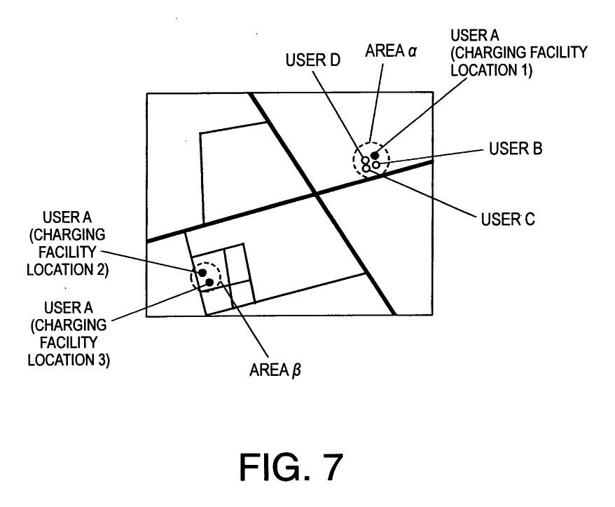

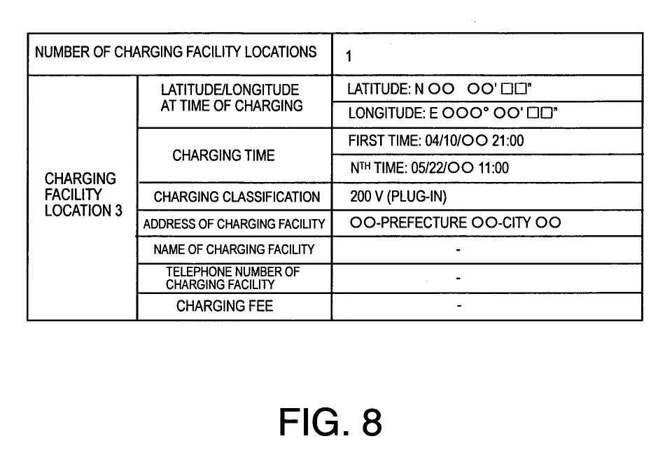

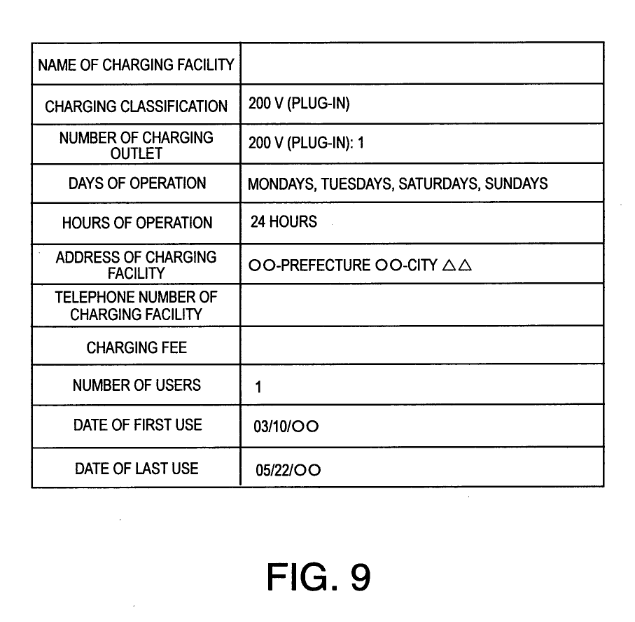

The following describes an example of processing that can be performed by the vehicle charging facility information acquisition system 10 in a situation in which the information center 100 receives charging record information for a “Charging Facility Location 3” in the same “Area r from the same user A as shown in FIG. 7. Also, FIG. 8 is a view showing an example of the charging record information for “Charging Facility Location 3” transmitted from the vehicle 20 of user A. In addition, FIG. 9 shows an example of the charging facility information that is generated based on the charging record information for “Charging Facility Location 3.”

In this example, a same-location determination is performed by the same-location determination function of the control device 110 in step S1 shown in FIG. 2 and discussed above. Also, the charging record information for “Charging Facility Location 2” in the same “Area β” has already been received from the same user A. Hence, a determination is made that the charging record information for “Charging Facility Location 3” currently received is charging record information that is obtained at the same location as the charging record information for “Charging Facility Location 2” already received.

In step S2, the charging facility information generation function of the control device 110 generates charging facility information. In this example, the charging facility information is generated in the same or a similar manner as in the case of the processing based on the charging facility information of “Charging Facility Location 2” described above. As a result, the “days of operation” information and the “date of last use” information, for example, of the charging facility information of the vehicle charging facility that is present in “Area β” are updated as shown in FIG. 9 based on the information shown in FIG. 6.

Also, in the example shown in FIG. 9, the “number of users” is one. This is the same number of users as in the case of the processing based on the charging facility information of “Charging Facility Location 2” described above. Accordingly, a determination is made in step S3 that the “number of users” is less than a predetermined number. The process then proceeds to step S6, and a determination is made that the vehicle charging facility is not generally available and is, for example, a household power source or the like that is at, for example, the personal residence of user A. Accordingly, the charging facility information is stored in the charging facility information database 140, and the processing ends.

Accordingly, the processing performed by the vehicle charging facility information acquisition system 10 based on the charging record information for “Charging Facility Location 3” in the example shown in FIG. 7 is executed in the manner described above.

In addition, as can be appreciated from the above, the information center 100 of the vehicle charging facility information acquisition system 10 can acquire charging record information, which is information of a vehicle charging facility that can be generated by a vehicle 20. The information center 100 can thus generate charging facility information, such as that shown in FIG. 5, based on the acquired charging record information. The information center 10 can therefore determine whether the vehicle charging facility that relates to the charging record information is a vehicle charging facility that is generally available. When it is determined that the vehicle charging facility is generally available, the information center 100 can, for example, wirelessly communicate the generated charging facility information to the vehicle 20. Therefore, information pertaining to a newly established vehicle charging facility that can be readily used by vehicles 20 can be appropriately provided in a timely manner to each of the vehicles 20.

In addition, when a determination is made as to whether a vehicle charging facility is generally available, the determination can be made based on whether the number of users is equal to or above a predetermined number as discussed above with regard to step S3 of FIG. 2 and on whether the vehicle charging facility is located within a company or other specific facility as discussed above with regard to step S4 of FIG. 2. It is therefore possible to determine, relatively easily and with high precision, whether a vehicle charging facility is generally available, that is, whether the vehicle charging facility is available to the general public.

Furthermore, when charging record information is created by the vehicle 20, information obtained from the charging equipment is also included by, for example, power line communication in addition to the information obtained by the vehicle 20. Thus, more detailed information relating to the vehicle charging facility can be obtained.

Also, as can be appreciated by one skilled in the art, the embodiments described herein merely serve to facilitate understanding of the present invention, and do not limit the present invention. Consequently, the elements disclosed in the embodiments disclosed herein also include all design modifications and/or equivalents belonging to the technical scope of the present invention.

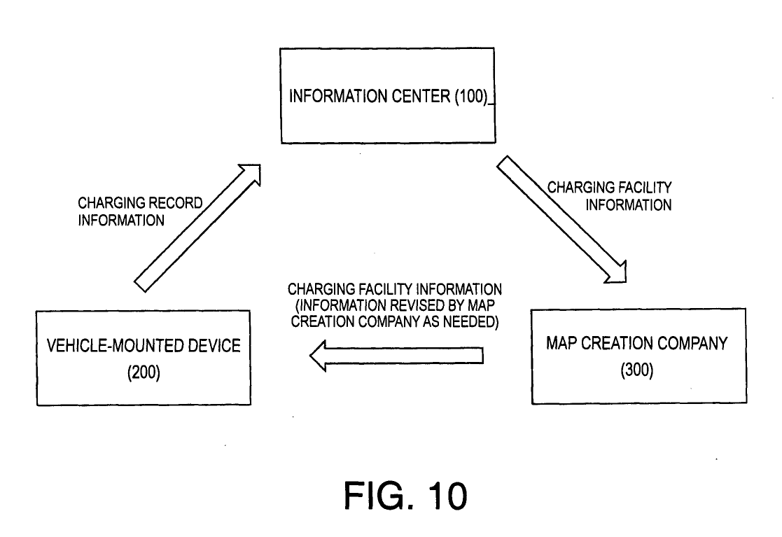

For example, in the embodiments disclosed herein, charging facility information generated by the control device 110 of the information center 100 can be transmitted by wireless communication to the vehicle-mounted device 200 of each vehicle 20. Thus, the charging facility information can be provided to the vehicle-mounted device 200 of each vehicle 20. However, a configuration may also be adopted in which charging facility information generated by the control device 110 of the information center 100 is sent, for example, wirelessly to a map creation company 300 or other suitable organization. The map creation company or other suitable organization can be referred to simply as a map creation company 300. The map creation company 300 can modify the information as needed, and provide the charging facility information to the vehicle mounted device 200 of each vehicle 20 as shown in FIG. 10. By adopting such a configuration, the charging facility information generated by the information center 100 can be adequately investigated by the map creation company 300. After the information is added to or modified by investigation, highly accurate charging facility information can be provided to each vehicle 20. Moreover, by providing the charging facility information generated by the control device 110 of the information center 100 to the map creation company 300, it is also possible to significantly reduce the burden on the map creation company 300 or other organization involved in examining the charging facilities.

Also, the processing for providing the charging facility information from the information center 100 to the map creation company 300, and the processing for providing the charging facility information from the map creation company 300 to each vehicle 20 are not particularly limited to the examples disclosed herein. For example, for all of the embodiment discussed herein, the charging facility information may be provided by wireless communication, or via wired communication or a bridge media or other storage medium. By providing the charging facility information via wired communication or a bridge media or other storage medium, it is possible to provide a relatively large amount of information at one time, and a wide range of charging facility information can therefore be appropriately provided at one time.

In addition, the vehicle-mounted device 200 of the embodiments discussed herein is provided with a power line communication device 240, and the information provided from the vehicle charging facility is received by power line communication with the charging equipment. However, a configuration may also be adopted in which a wireless communication device is provided instead of the power line communication device 240, and the information provided from the vehicle charging facility can be received by wireless communication.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a vehicle 20 used with a vehicle charging facility information acquisition system as described herein. Accordingly, these terms, as utilized to describe the present invention should be interpreted relative to a vehicle 20 that can be used with a vehicle charging facility information acquisition system. The term “detect” as used herein to describe an operation or function carried out by a component, a section, a device or the like includes a component, a section, a device or the like that does not require physical detection, but rather includes determining, measuring, modeling, predicting or computing or the like to carry out the operation or function. The term “configured” as used herein to describe a component, section or part of a device includes hardware and/or software that is constructed and/or programmed to carry out the desired function. The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

1. A vehicle charging facility information acquisition system comprising:
an acquisition component, configured to acquire, from a plurality of vehicles, information pertaining to a vehicle charging facility as charging record information when the vehicles use the vehicle charging facility, the information including at least charging facility position information pertaining to a location of the vehicle charging facility; and
a charging record information storage component configured to store the acquired charging record information in a charging record information database.

2. The vehicle charging facility information acquisition system according to claim 1, further comprising:
a charging facility information generation component configured to generate, on the basis of the charging record information, charging facility information pertaining to the vehicle charging facility.

3. The vehicle charging facility information acquisition system according to claim 2, further comprising:
a determination component configured to determine, on the basis of the charging facility information, whether the vehicle charging facility that relates to the charging record information is a vehicle charging facility that is accessible by the plurality of vehicles.

4. The vehicle charging facility information acquisition system according to claim 3, further comprising:
an information providing component configured to provide to at least one of the vehicles the information pertaining the vehicle charging facility that has been determined by the determination component to be accessible by the plurality of vehicles.

5. The vehicle charging facility information acquisition system according to claim 3 wherein
the determination component is configured to determine that the vehicle charging facility that relates to the charging record information is a vehicle charging facility that is accessible to the plurality of vehicles when the charging record information indicates that the charging facility has been accessed by at least a predetermined number of vehicles.

6. The vehicle charging facility information acquisition system according to claim 3, further comprising
a storage device configured to store map information; and
the determination component is configured to determine, based on the charging record information and the map information, whether the vehicle charging facility that relates to the charging record information is a vehicle charging facility that is accessible by a plurality of vehicles.

7. The vehicle charging facility information acquisition system according to claim 1, wherein
the charging record information includes information determined by one of the vehicles and information acquired from the vehicle charging facility by the one of the vehicles.

8. The vehicle charging facility information acquisition system according to claim 7, wherein
the acquisition component is further configured to assign a priority value to the information acquired from the vehicle charging facility by the one of the vehicles, the priority value being higher in priority than a different priority value assigned to the information determined by the one of the vehicles.

9. The vehicle charging facility information acquisition system according to claim 4, wherein
the information providing component is configured to provide the information pertaining the vehicle charging facility via a map creation facility to the at least one of the vehicles.

10. The vehicle charging facility information acquisition system according to claim 4, wherein
the information providing component is configured to provide the information pertaining the vehicle charging facility via wired communication or a storage medium to the at least one of the vehicles.

11. A vehicle charging facility information transmission apparatus in a vehicle, the vehicle charging facility information transmission apparatus comprising:
a charging record information transmission component configured to transmit information pertaining to a vehicle charging facility as charging record information from the vehicle to an information center when the vehicle uses the vehicle charging facility, the information including at least charging facility position information pertaining to a location of the vehicle charging facility.

12. A method for acquiring vehicle charging facility information comprising:
acquiring information pertaining to a vehicle charging facility as charging record information from a plurality of vehicles when the vehicles use the vehicle charging facility, the information including at least charging facility position information pertaining to a location of the vehicle charging facility; and
storing the acquired charging record information in a charging record information database.

13. The method according to claim 12, further comprising:
generating, on the basis of the charging record information, charging facility information pertaining to the vehicle charging facility.

14. The method according to claim 13, further comprising:
determining, on the basis of the charging facility information, whether the vehicle charging facility that relates to the charging record information is a vehicle charging facility that is accessible by the plurality of vehicles.

15. The method according to claim 14, further comprising:
providing to at least one of the vehicles the information pertaining the vehicle charging facility that has been determined by the determining operation to be accessible by the plurality of vehicles.

16. The method according to claim 14 wherein
the determining is configured to determine that the vehicle charging facility that relates to the charging record information is a vehicle charging facility that is accessible to the plurality of vehicles when the charging record information indicates that the charging facility has been accessed by at least a predetermined number of vehicles.

17. The method according to claim 14 through 16, further comprising
storing map information; and
the determining is configured to determine, based on the charging record information and the map information, whether the vehicle charging facility that relates to the charging record information is a vehicle charging facility that is accessible by a plurality of vehicles.

18. The method according to claim 12, wherein
the charging record information includes information determined by one of the vehicles and information acquired from the vehicle charging facility by the one of the vehicles.

19. The method according to claim 18, wherein
the acquiring is further configured to assign a priority value to the information acquired from the vehicle charging facility by the one of the vehicles, the priority value being higher in priority than a different priority value assigned to the information determined by the one of the vehicles.

20. The method according to claim 15, wherein
the providing is configured to provide the information pertaining the vehicle charging facility via a map creation facility to the at least one of the vehicles.
